(19) United States
(12) Patent Application Publication
(10) Pub. No.: US 2011/0196105 A1
(43) Pub. Date: Aug. 11, 2011

(54) NOVEL HIGH PRESSURE, LOW DENSITY POLYETHYLENE RESINS PRODUCED THROUGH THE USE OF HIGHLY ACTIVE CHAIN TRANSFER AGENTS

(75) Inventors: Christopher R. Eddy, Lake Jackson, TX (US); John O. Osby, Lake Jackson, TX (US); Mehmet Demirors, Pearland, TX (US); Stefan Hinrichs, Terneuzen (NL)

(73) Assignee: Dow Global Technologies Inc., Midland, MI (US)

(21) Appl. No.: 12/701,859

(22) Filed: Feb. 8, 2010

(51) Int. Cl. C08G 79/02; C08L 85/02; C08L 23/06; C08L 23/00

(52) U.S. Cl. 525/287; 528/398; 525/538

(57) ABSTRACT

In one aspect the invention is a reaction product comprising ethylene and at least one cyclic phosphine wherein the reaction product has a non-extractable phosphorous concentration of at least 10 parts per million by weight, and preferably a maximum of at least about 10000 ppm by weight, preferably wherein the reaction product has a density from about 0.90 to about 0.94 in grams per cubic centimeter, a molecular weight distribution (M_{w}/Mₙ) from about 2 to about 30.

### BACKGROUND OF THE INVENTION

Compositions and processes for forming low density ethylene-based polymers such as high pressure, low density polyethylene (LDPE) resins are disclosed. For many years, LDPE has been produced in autoclave reactors, tubular reactors, and combinations thereof. Each type of reactor has its advantages and disadvantages, but economics and product design drive the need for improvements. The operation of and type(s) of reactor(s) employed can dramatically affect the physical properties of the resulting LDPE. Such improvements are desired for applications such as blown and cast film, where especially good optical properties are desired.

High pressure, low density ethylene-based polymers have a density in a range of about 0.91 to about 0.94 g/cm³. Low density ethylene-based polymers typically have random branching structures that contain both alkyl substituents (short chain branches) as well as long chain branches. Most LDPE polymers are homopolymers, although some are copolymers and interpolymers, typically using other α-olefin comonomers.

Chain transfer agents (CTAs), or “telogens”, are often used to control the melt flow index in a free-radical polymerization process. “Chain transfer” involves the termination of growing polymer chains, thus limiting the ultimate molecular weight of the polymer material. Chain transfer agents are typically hydrogen atom donors that react with a growing polymer chain and stop the polymerization reaction of the chain. Known CTAs include many types of hydrogen atom donor compounds, such as saturated or unsaturated hydrocarbons, aldehydes, ketones, and alcohols. By manipulating the concentration and type of chain transfer agent used in a process, one can affect the average length and molecular weight distribution of the polymer chains. This in turn affects the melt index (I₂), which is related to molecular weight.

Many chain transfer agents are known in the art for use in high-pressure, low density polyethylene production. Example references that include information on the use of chain transfer agents in free-radical polymerization of ethylene and ethylene-based polymers include Ehrlich, P., and Mortimer, G. A., “Fundamentals of the Free-Radical Polymerization of Ethylene”, Advanced Polymers, Vol. 7, 386-448 (1970); Mortimer, George A., “Chain Transfer in Ethylene Polymerization—IV. Additional Study at 1360 Atm and 130 “C”, Journal of Polymer Science, Part A-1, Vol. 8, 1513-23 (1970); Mortimer, George A., “Chain Transfer in Ethylene Polymerization—VI. The Effect of Pressure”, Journal of Polymer Science, Part A-1, Vol. 8, 1543-48 (1970); Mortimer, George A., “Chain Transfer in Ethylene Polymerization—VII. Very Reactive and Depletable Transfer Agents”, Journal of Polymer Science, Part A-1, Vol. 10, 163-168 (1972); Great Britain Patent No. 997,408 (Cave); U.S. Pat. No. 3,377,330 (Mortimer); U.S. Patent Publication No. 2004/0054097 (Maehling, et al.); and U.S. Pat. Nos. 6,596,241; 6,673,878; and 6,899,852 (Donck).

After hydrogen atom donation, it is known in the art that a chain transfer agent may form a radical which can react with a monomer, an oligomer, or a comonomer, and start a new polymer chain. The result is that the original CTA is incorporated into a new or existing polymer chain, thereby introducing a new functionality into the polymer chain associated with the original CTA. The CTA may introduce new functionality into the polymer chain that is not normally the result of the monomer/comonomer polymerization.

Low density ethylene-based polymers produced in the presence of CTAs are modified in a number of physical properties, such as processability; film optical properties such as haze, gloss and clarity; density; stiffness; yield point; film draw; and tear strength. For example, an α-olefin acting as a CTA could also introduce a short chain branch into a polymer chain upon incorporation.

### SUMMARY OF THE INVENTION

In one aspect the invention is a reaction product comprising ethylene and at least one cyclic phosphine wherein the reaction product has a non-extractable phosphorous concentration of at least 10 parts per million by weight, and preferably a maximum of at least about 10000 ppm by weight, preferably wherein the reaction product has a density from about 0.90 to about 0.94 in grams per cubic centimeter, a molecular weight distribution (M_{w}/Mₙ) from about 2 to about 30.

Preferably the reaction product is odorless.

More preferably the cyclic phosphine corresponds to the following structure:

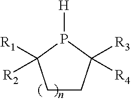

wherein n is an integer from 0 to 10, preferably wherein R₁, R₂, R₃, and R₄ are not hydrogen, more preferably wherein R₁, R₂, R₃, and R₄ are independently selected from the group consisting of C₁-C₆ alkyl groups.

In another aspect, the invention is a reaction product consisting essentially of ethylene and at least one cyclic phosphine wherein the reaction product has a non-extractable phosphorous concentration of at least 10 parts per million by weight, and preferably a maximum of at least about 10000 ppm by weight, wherein the reaction product comprises no additional anti-oxidant, preferably wherein the reaction product has a density from about 0.90 to about 0.94 in grams per cubic centimeter, a molecular weight distribution (M_{w}/Mₙ) from about 2 to about 30.

A film layer comprising the reaction product of either aspect can also be made.

A composition comprising the reaction product of claims either aspect and at least one other natural or synthetic polymer can also be made, preferably wherein the synthetic polymer is selected from the group consisting of high density polyethylene (HDPE), linear low density polyethylene (LLDPE), high pressure low density polyethylene (LDPE), olefin block copolymers (OBC), polypropylene, homogeneous linear ethylene polymers, and homogeneous substantially linear ethylene polymers.

The reaction product of either aspect can be at least partially cross-linked to a gel level of at least 5 weight percent.

The reaction product of either aspect can further comprise at least one chain transfer agent other than a cyclic phosphine.

The reaction product of either aspect can further comprise at least one C₃-C₂₀ alpha olefin.

The reaction product of either aspect can have a long chain branching structure as characterized by a gpcBR value greater than 0.05 as determined by a gpcBR Branching Index and a GPC-LS Characterization value greater than 2.1 as determined by a GPC-LS Characterization method.

### BRIEF DESCRIPTION OF THE DRAWINGS

None

### DETAILED DESCRIPTION OF THE INVENTION

The disclosed compositions are low density ethylene-based polymers having a narrow molecular weight distribution, which can be used for blown and cast films used alone or in blends with other polymers, created in a free-radical polymerization of ethylene, and optionally a comonomer, in the presence of at least one chain transfer agent (CTA). At least one of the chain transfer agents is a high-activity cyclic phosphine CTA.

In typical high pressure free radical LDPE production processes, “low-activity” chain transfer agents are typically used to control reactions in the process. A low-activity CTA has a chain transfer constant (Cs) that is less than 1. For example, at certain conditions propionaldehyde has a Cs ˜0.33 as reported in Mortimer, George A., “Chain Transfer in Ethylene Polymerization—VII. Very Reactive and Depletable Transfer Agents”, Journal of Polymer Science, Part A-1, Vol. 10, 163-168 (1972). The chain transfer constant, Cs, for a chain transfer agent is defined as the ratio of the reaction rate constant for the chain transfer agent relative to the reaction rate constant for propagation of the monomer. A high-activity CTA has a chain transfer constant (Cs) that is at least 1 or more.

Polymers produced in the presence of chain transfer agents, especially high-Cs chain transfer agents, may have interesting physical and chemical properties due to incorporation of the chain transfer agents. Properties that may be modified include its processibility (e.g., shear viscosity), optical properties such as haze and clarity, density, stiffness, yield point, film draw and tear strength.

Low density ethylene-based polymer products having a narrow molecular weight distribution are very suitable for the production of high-clarity LDPE blown and cast films.

Disclosed is a low density ethylene-based polymer that has a density in a range of about 0.90 and 0.94 g/cm³. Disclosed is a low density ethylene-based polymer that has a molecular weight distribution, M_{w}/Mₙ, in a range of about 2 to about 30. Disclosed is a low density ethylene-based polymer that has a melt index, I₂, from about 0.1 to about 50 grams per 10 minutes. The disclosed ethylene-based polymer may further comprise a non-extractable phosphorous concentration of a minimum of at least 10 parts per million by weight, preferably 20 parts per million up to a maximum of about 10000 ppm by weight, preferably a maximum of about 4000 parts per million by weight.

The disclosed low density ethylene-based polymer may be a homopolymer of ethylene. The disclosed low density ethylene-based polymer may be an ethylene-based interpolymer comprised of ethylene and at least one comonomer. Comonomers useful for incorporation into an ethylene-based interpolymer, especially an ethylene/α-olefin interpolymer include, but are not limited to, propylene, isobutylene, 1-butene, 1-pentene, 1-hexene, 3-methyl-1-pentene, 4-methyl-1-pentene, and 1-octene, non-conjugated dienes, polyenes, butadienes, isoprenes, pentadienes, hexadienes (for example, 1,4-hexadiene), octadienes, styrene, halo-substituted styrene, alkyl-substituted styrene, tetrafluoroethylenes, vinylbenzocyclobutene, naphthenics, cycloalkenes (for example, cyclopentene, cyclohexene, cyclooctene), and mixtures thereof. Ethylene is frequently copolymerized with at least one C₃-C₂₀ α-olefin, such as propene, 1-butene, 1-hexene and 1-octene.

In simple terms, the disclosed processes are high pressure free radical reactor processes for the polymerization of ethylene and, optionally, at least one comonomer, into a low density ethylene-based polymer adduct and byproduct heat. The disclosed processes describe the use of at least one high-Cs, and in some cases a mixture of at least one high-Cs and at least one low-Cs, chain transfer agents to assist in the formation of a narrower molecular weight distribution low density ethylene-based polymer than traditionally made.

Disclosed processes can use a number of physical means to result in the low density ethylene-based polymerization reaction. Envisioned processes where at least one high-Cs chain transfer agent is used to create the disclosed ethylene-based polymer products include a single or multiple autoclaves, a combination of one or more autoclaves and a tubular reactor, operated in series and in sequential order, and a single tubular reactor. The processes may be performed using a continuous process. Additionally, it is envisioned that the monomer (and comonomer, if used) components may be fed into the process entirely in the beginning or at the front (for a continuous-type process) or may be parsed and fed into the process at several different locations (for a continuous-type process) during the reaction cycle. As well, the chain transfer agent may be included with or added to some or all of the monomer/comonomer additions or streams. This flexibility in addition of monomer/comonomer feed streams as well as the addition of chain transfer agents gives the operator of a process the flexibility and utility to create the disclosed ethylene-based polymer products.

Included in this disclosure is the non-limiting description of a free-radical initiated low density ethylene-based polymerization reaction for a tubular reactor process. Besides feeding the reactor ethylene and, optionally, at least one comonomer, other components are fed to the reactor to initiate and support the free radical reaction as the ethylene-based polymer adduct is formed, such as reaction initiators, catalysts, and chain transfer agents.

Methods are well known in the art for using a tubular reactor to form low density ethylene-based polymers. The process is a tubular polymerization reaction where a process fluid partially comprised of ethylene is free-radically polymerized creating a highly exothermic reaction. The reaction occurs under high operating pressure (1000 bar to 4000 bar) in turbulent process fluid flow (hence low density ethylene-based polymers also referred to as “high pressure” polymers) at maximum temperatures in the reactor of 160° C. to 360° C., while the initial initiation temperature for the reaction is between 120° C. to 200° C. At certain points along the tube, a portion of the heat produced during the free-radical polymerization may be removed through the tube wall. Typical single-pass conversion values for a tubular reactor range from about 20-40 percent. Tubular reactor systems also include at least one monomer recycle loop to improve conversion efficiency.

The type of free radical initiator to be used in the disclosed processes is not critical. Examples of free radical initiators include oxygen-based initiators such as organic peroxides (PO). Preferred initiators are t-butyl peroxy pivalate, di-t-butyl peroxide, t-butyl peroxy acetate, and t-butyl peroxy-2-ethylhexanoate, and mixtures thereof. These organic peroxy initiators are used in conventional amounts of between 0.0001 and 0.01 weight percent based upon the weight of high pressure feed.

The free-radical polymerization reaction resulting in the disclosed ethylene-based polymer adduct occurs in each reaction zone where initiator or catalyst is present. The reaction is an exothermic reaction that generates a large quantity of heat. Without cooling, the adiabatic temperature rise in the process fluid and the ethylene-based polymer adduct (which absorbs and retains heat) would result in unfavorable reactions. Such reactions may include ethylene decomposition (where ethylene and polyethylene breaks down in a combustionless reaction into base products) or excessive long chain branching, which would lead to a broadening of the molecular weight distribution.

In some disclosed processes where more than one CTA is used, one of the chain transfer agents has a Cs less than one and another chain transfer agent has a Cs greater than one. In such processes, the chain transfer agents may be fed to the system at different feed rates or amounts so as to customize their effectiveness in different parts of the process or to optimize the ethylene-based polymer properties. In some other disclosed processes, the feed rate of the low activity CTA may be regulated by the amount of recycled low activity CTA detected in either or both recycle streams. The feed amounts and ratio of chain transfer agents may also be regulated based upon final ethylene-based polymer characteristics, such as melt viscosity, overall production amount, target molecular weight distribution, desired melt index, first zone peak temperature, residual CTAs or CTA byproducts, and tube process fluid velocity.

In disclosed processes, the concentration of cyclic phosphine chain transfer agent in the process fluid is from about 1 to about 30000 weight ppm, and preferably from about 1 to about 10000 weight ppm.

End-use products made using the disclosed ethylene-based polymers include all types of films (for example, blown, cast and extrusion coatings (monolayer or multilayer)), molded articles (for example, blow molded and rotomolded articles), wire and cable coatings and formulations, cross-linking applications, foams (for example, blown with open or closed cells), and other thermoplastic applications. The disclosed ethylene-based polymers are also useful as a blend component with other polyolefins.

The types of films that may be produced as end-use products from the disclosed ethylene-based polymers include silage films, sealants, silobags, stretch; BOPE, display packaging, shrink films, heavy duty shipping sacks. Additionally, blown, cast and extrusion coatings (monolayer or multilayer) also may be produced using the disclosed ethylene-based polymers.

### Definitions

The term odorless means no more odor than conventional LDPE made without a cyclic phosphine chain transfer agent.

The terms “blend” or “polymer blend” generally means a mixture of two or more polymers. A blend may or may not be miscible (not phase separated at molecular level). A blend may or may not be phase separated. A blend may or may not contain one or more domain configurations, as determined from transmission electron spectroscopy, light scattering, x-ray scattering, and other methods known in the art.

The term “composition” includes a mixture of materials which comprise the composition as well as reaction products and decomposition products formed from interaction and reaction between the materials of the composition.

The term “ethylene-based polymer” refers to a polymer that contains more than 50 mole percent polymerized ethylene monomer (based on the total amount of polymerizable monomers), and, optionally, may contain at least one comonomer. A homopolymer of ethylene is an ethylene-based polymer.

The term “homopolymer” is a polymer that contains only a single type of monomer.

The term “interpolymer” refers to polymers prepared by the polymerization of at least two different types of monomers. The term interpolymer includes copolymers, usually employed to refer to polymers prepared from two different monomers, and polymers prepared from more than two different types of monomers, such as terpolymers.

The term “LDPE” may also be referred to as “high pressure ethylene polymer” or “highly branched polyethylene” and is defined to mean that the polymer is partly or entirely homopolymerized in autoclave or tubular reactors at pressures above 13,000 psig with the use of free-radical initiators, such as peroxides (see, for example, U.S. Pat. No. 4,599,392 (McKinney, et al.)).

The term “polymer” refers to a compound prepared by polymerizing monomers, whether of the same or a different type of monomer. The term polymer embraces the terms “homopolymer” and “interpolymer”.

### Testing Methods

### Non-Extractable Phosphorous Concentration:

### Resin Dissolution and Re-Precipitation Using Total Dissolution Methodology (TDM):

1. Weigh about 10 grams of resin pellets into a container and fill the container with liquid nitrogen to cool and harden the polymer.

2. Grind the cooled resin with a grinding mill.

3. Weigh (and record to the nearest 0.0001-g) 1.0±0.1 g of resin into 4-oz glass bottle

4. Add a PTFE-coated stirrer bar to the bottle followed by addition of 25 mL of 0.04% triethyl phosphite in o-xylene using a solvent dispenser. Cap the bottle.

5. Place the bottle on the heated stirrer and heat the sample solution for 30 minutes at 130° C. with stirring. The bottle cap should be loose.

6. Remove the bottle from heat and cool the solution to room temperature with stiffing for at least 2 hours. The bottle cap should be tight.

7. Add 50 mL of methanol to the bottle using a solvent disperser. The methanol should be delivered at a rate of 50 mL/min. The solution must be stirred during this addition. The solution is stirred for 2 hours. The bottle cap should be tight.

8. Remove the bottle from the stirrer and allow solid to settle. Decant the solution and dry the remaining solid. Analyze the dried solid by XRF for non-extractable phosphorous.

One such conference proceeding which details extractions can be found at: S. Green, S. Bai, and R. Cong, “Simple methodology for quantitation of additives (I-1010, I-1076, and I-168) in polyolefins using dissolution/re-precipiation and liquid chromatographic analysis,” 33rd International Symposium on Capillary Chromatography and Electrophoresis, Portland, Oreg., May 18, 2009.

Total Phosphorous Concentration: The total concentration of phosphorous found in the ethylene-based polymer product—both molecularly bonded to the ethylene-based polymer and “free” phosphorous (i.e., phosphorous contained in byproduct and other compounds homogeneously incorporated with the ethylene-based polymer)—is determined by X-ray fluorescence (XRF) using an PANalytical Axios X-ray fluorescence (XRF) spectrometer with a Rh tube. The XRF spectrometer is calibrated by using polymer standards which has known amounts of phosphorus based upon gravimetric additions. It is understood that the letter “P” in this instance refers to elemental phosphorous. The XRF method has a phosphorous detection limit of 5 ppm by weight based upon the signal-to-noise count rates. All standards and samples were measured under vacuum conditions. For each measurement, approximately 10 g of ethylene-based polymer is hot pressed into a 50 mm diameter disk, resulting in a specimen about 6 mm thick. The sample disks are then placed into an appropriate measuring cup for analysis. The XRF spectrometer is set to the conditions listed in Table 1 for each test and the test performed.

TABLE 1
XRF spectrometer conditions for the analysis of total phosphorous

| Attribute | Setting |
|---|---|
| Channel | P |
| Line | KA |
| Crystal | Ge 111—C |
| Collimator | 300 μm |
| Collimator mask | 37 mm |
| Detector | Flow |
| Tube filter | Be (150 μm) |
| kV | 24 |
| mA | 100 |
| Angle (°2T) | 140.8120 |
| Offset Background1 (°2T) | 1.7500 |
| Measurement time | 30 s (for each channel) |
| Background method | Calculated factors |

A linear calibration curve based upon phosphorous concentration is determined from the intensity responses from characterized polymer standards. The linear calibration curve is used to calculate the total phosphorous concentration in each sample.

### Density

Samples for density measurement are prepared according to ASTM D 1928. Measurements are made within one hour of sample pressing using ASTM D792, Method B.

### Melt Index

Melt index, or I₂, is measured in accordance with ASTM D 1238, Condition 190° C./2.16 kg.

### Triple Detector Gel Permeation Chromatography

The Triple Detector Gel Permeation Chromatography (3D-GPC or TD-GPC) system consists of a Waters (Milford, Mass) 150 C high temperature chromatograph (other suitable high temperatures GPC instruments include Polymer Laboratories (Shropshire, UK) Model 210 and Model 220) equipped with an on-board differential refractometer (RI). Additional detectors can include an IR4 infra-red detector from Polymer ChAR (Valencia, Spain), Precision Detectors (Amherst, Mass.) 2-angle laser light scattering (LS) detector Model 2040, and a Viscotek (Houston, Tex.) 150R 4-capillary solution viscometer. A GPC with these latter two independent detectors and at least one of the former detectors is sometimes referred to as “3D-GPC” while the term “GPC” alone generally refers to conventional GPC. Depending on the sample, either the 15° angle or the 90° angle of the light scattering detector is used for calculation purposes. Data collection is performed using Viscotek TriSEC software, Version 3, and a 4-channel Viscotek Data Manager DM400. The system is also equipped with an on-line solvent degassing device from Polymer Laboratories (Shropshire, United Kingdom).

Suitable high temperature GPC columns can be used such as four 30 cm long Shodex HT803 13 micron columns or four 30 cm Polymer Labs columns of 20-micron mixed-pore-size packing (MixA LS, Polymer Labs). The sample carousel compartment is operated at 140° C. and the column compartment is operated at 150° C. The samples are prepared at a concentration of 0.1 grams of polymer in 50 milliliters of solvent. The chromatographic solvent and the sample preparation solvent contain 200 ppm of trichloro benzene (TCB). Both solvents are sparged with nitrogen. The polyethylene samples are gently stirred at 160° C. for four hours. The injection volume is 200 microliters. The flow rate through the GPC is set at 1 ml/minute.

The GPC column set is calibrated by running 21 narrow molecular weight distribution polystyrene standards. The molecular weight (MW) of the standards ranges from 580 to 8,400,000, and the standards are contained in 6 “cocktail” mixtures. Each standard mixture has at least a decade of separation between individual molecular weights. The standard mixtures are purchased from Polymer Laboratories. The polystyrene standards are prepared at 0.025 g in 50 mL of solvent for molecular weights equal to or greater than 1,000,000 and 0.05 g in 50 mL of solvent for molecular weights less than 1,000,000. The polystyrene standards were dissolved at 80° C. with gentle agitation for 30 minutes. The narrow standards mixtures are run first and in order of decreasing highest molecular weight component to minimize degradation. The polystyrene standard peak molecular weights are converted to polyethylene molecular weight using Equation 2 (as described in Williams and Ward, J. Polym. Sci., Polym. Let., 6, 621 (1968)):

M_{polyethylene}=A×(M_{polystyrene})^{B} (Eq. 2),

where M is the molecular weight of polyethylene or polystyrene (as marked), and B is equal to 1.0. It is known to those of ordinary skill in the art that A may be in a range of about 0.38 to about 0.44 and is determined at the time of calibration using a broad polyethylene standard, as outlined in the gpcBR Branching Index by 3D-GPC method, infra, and specifically Equation 5. Use of this polyethylene calibration method to obtain molecular weight values, such as M_{w}/Mₙ, and related statistics, is defined here as the method of Williams and Ward.

The systematic approach for the determination of multi-detector offsets is performed in a manner consistent with that published by Balke, Mourey, et al. (Mourey and Balke, Chromatography Polym., Chapter 12, (1992)) (Balke, Thitiratsakul, Lew, Cheung, Mourey, Chromatography Polym., Chapter 13, (1992)), optimizing triple detector log (M_{w} and intrinsic viscosity) results from Dow 1683 broad polystyrene (American Polymer Standards Corp.; Mentor, Ohio) or its equivalent to the narrow standard column calibration results from the narrow polystyrene standards calibration curve. The molecular weight data is obtained in a manner consistent with that published by Zimm (Zimm, B. H., J. Chem. Phys., 16, 1099 (1948)) and Kratochvil (Kratochvil, P., Classical Light Scattering from Polymer Solutions, Elsevier, Oxford, N.Y. (1987)). The overall injected concentration used in the determination of the molecular weight is obtained from the mass detector area and the mass detector constant derived from a suitable linear polyethylene homopolymer, or one of the polyethylene standards of known weight average molecular weight. The calculated molecular weights are obtained using a light scattering constant derived from one or more of the polyethylene standards mentioned and a refractive index concentration coefficient, do/dc, of 0.104. Generally, the mass detector response and the light scattering constant should be determined from a linear standard with a molecular weight in excess of about 50,000 daltons. The viscometer calibration can be accomplished using the methods described by the manufacturer or alternatively by using the published values of suitable linear standards such as Standard Reference Materials (SRM) 1475a, 1482a, 1483, or 1484a. The chromatographic concentrations are assumed low enough to eliminate addressing 2^{nd} viral coefficient effects (concentration effects on molecular weight).

gpcBR Branching Index by 3D-GPC

In the 3D-GPC configuration, the polyethylene and polystyrene standards can be used to measure the Mark-Houwink constants, K and α, independently for each of the two polymer types, polystyrene and polyethylene. These can be used to refine the Williams and Ward polyethylene equivalent molecular weights in application of the following methods.

The gpcBR branching index is determined by first calibrating the light scattering, viscosity, and concentration detectors as described previously. Baselines are then subtracted from the light scattering, viscometer, and concentration chromatograms. Integration windows are then set to ensure integration of all of the low molecular weight retention volume range in the light scattering and viscometer chromatograms that indicate the presence of detectable polymer from the refractive index chromatogram. Linear polyethylene standards are then used to establish polyethylene and polystyrene Mark-Houwink constants as described previously. Upon obtaining the constants, the two values are used to construct two linear reference conventional calibrations for polyethylene molecular weight and polyethylene intrinsic viscosity as a function of elution volume, as shown in Equations 3 and 4:

$$\begin{matrix}{M}_{PE} = {( \frac{{K}_{PS}}{{K}_{PE}} )}^{1 / {α}_{PE} + 1} \cdot {M}_{PS}^{{α}_{PS} + 1 / {α}_{PE} + 1} , and & ( Eq . 3 ) \\ {[ η ]}_{PE} = {K}_{PS} \cdot {M}_{PS}^{α + 1} / {M}_{PE} . & ( Eq . 4 )\end{matrix}$$

The gpcBR branching index is a robust method for the characterization of long chain branching. Yau, Wallace W., “Examples of Using 3D-GPC—TREF for Polyolefin Characterization”, Macromol. Symp., 2007, 257, 29-45. The index avoids the slice-by-slice 3D-GPC calculations traditionally used in the determination of g′ values and branching frequency calculations in favor of whole polymer detector areas. From 3D-GPC data, one can obtain the sample bulk absolute weight average molecular weight (M_{w, Abs}) by the light scattering (LS) detector using the peak area method. The method avoids the slice-by-slice ratio of light scattering detector signal over the concentration detector signal as required in a traditional g′ determination.

With 3D-GPC, absolute weight average molecular weight (“M_{w, Abs}”) and intrinsic viscosity are also obtained independently using Equations 5 and 6:

$$\begin{matrix}{M}_{W} = {\sum }_{i} {w}_{i} {M}_{i} \\ = {\sum }_{i} ( \frac{{C}_{i}}{{\sum }_{i} {C}_{i}} ) {M}_{i} \\ = \frac{{\sum }_{i} {C}_{i} {M}_{i}}{{\sum }_{i} {C}_{i}} \\ = \frac{{\sum }_{i} {LS}_{i}}{{\sum }_{i} {C}_{i}} \\ = \frac{LS Area}{Conc . Area}\end{matrix} \qquad ( Eq . 5 )$$

The area calculation in Equation 5 offers more precision because as an overall sample area it is much less sensitive to variation caused by detector noise and GPC settings on baseline and integration limits. More importantly, the peak area calculation is not affected by the detector volume offsets. Similarly, the high-precision sample intrinsic viscosity (IV) is obtained by the area method shown in Equation 6:

$$\begin{matrix}IV = [ η ] \\ = {\sum }_{i} {w}_{i} {IV}_{i} \\ = {\sum }_{i} ( \frac{{C}_{i}}{{\sum }_{i} {C}_{i}} ) {IV}_{i} \\ = \frac{{\sum }_{i} {C}_{i} {IV}_{i}}{{\sum }_{i} {C}_{i}} \\ = \frac{{\sum }_{i} {DP}_{i}}{{\sum }_{i} {C}_{i}} \\ = \frac{DP Area}{Conc . Area} ,\end{matrix} \qquad ( Eq . 6 )$$

where DPᵢ stands for the differential pressure signal monitored directly from the online viscometer.

To determine the gpcBR branching index, the light scattering elution area for the sample polymer is used to determine the molecular weight of the sample. The viscosity detector elution area for the sample polymer is used to determine the intrinsic viscosity (IV or [η]) of the sample.

Initially, the molecular weight and intrinsic viscosity for a linear polyethylene standard sample, such as SRM1475a or an equivalent, are determined using the conventional calibrations (“cc”) for both molecular weight and intrinsic viscosity as a function of elution volume, per Equations 7 and 8:

$$\begin{matrix}{Mw}_{CC} = {\sum }_{i} ( \frac{{C}_{i}}{{\sum }_{i} {C}_{i}} ) {M}_{i} = {\sum }_{i} {w}_{i} {M}_{cc , i} , \\ and & ( Eq . 7 ) \\ {[ η ]}_{CC} = {\sum }_{i} ( \frac{{C}_{i}}{{\sum }_{i} {C}_{i}} ) {IV}_{i} = {\sum }_{i} {w}_{i} {IV}_{cc , i} . & ( Eq . 8 )\end{matrix}$$

Equation 9 is used to determine the gpcBR branching index:

$$gpcBR = [ ( \frac{{[ η ]}_{CC}}{[ η ]} ) \cdot {( \frac{{M}_{W}}{{M}_{W , CC}} )}^{{α}_{PE}} - 1 ] , \qquad ( Eq . 9 )$$

wherein [η] is the measured intrinsic viscosity, [η]_{cc} is the intrinsic viscosity from the conventional calibration, M_{w} is the measured weight average molecular weight, and M_{w,cc} is the weight average molecular weight of the conventional calibration. The weight average molecular weight by light scattering (LS) using Equation (5) is commonly referred to as “absolute weight average molecular weight” or “M_{w, Abs}”. The M_{w,cc} from Equation (7) using conventional GPC molecular weight calibration curve (“conventional calibration”) is often referred to as “polymer chain backbone molecular weight”, “conventional weight average molecular weight”, and “M_{w,GPC}”.

All statistical values with the “cc” subscript are determined using their respective elution volumes, the corresponding conventional calibration as previously described, and the concentration (Cᵢ) derived from the retention volume molecular weight calibration. The non-subscripted values are measured values based on the mass detector, LALLS, and viscometer areas. The value of K_{PE} is adjusted iteratively until the linear reference sample has a gpcBR measured value of zero. For example, the final values for α and Log K for the determination of gpcBR in this particular case are 0.725 and −3.355, respectively, for polyethylene, and 0.722 and −3.993 for polystyrene, respectively.

Once the K and α values have been determined using the procedure discussed previously, the procedure is repeated using the branched samples. The branched samples are analyzed using the final Mark-Houwink constants as the best “cc” calibration values and Equations 5-8 are applied.

The interpretation of gpcBR is straight forward. For linear polymers, gpcBR calculated from Equation 9 will be close to zero since the values measured by LS and viscometry will be close to the conventional calibration standard. For branched polymers, gpcBR will be higher than zero, especially with high levels of long chain branching, because the measured polymer molecular weight will be higher than the calculated M_{w,cc}, and the calculated IV_{cc} will be higher than the measured polymer IV. In fact, the gpcBR value represents the fractional IV change due the molecular size contraction effect as the result of polymer branching. A gpcBR value of 0.5 or 2.0 would mean a molecular size contraction effect of IV at the level of 50% and 200%, respectively, versus a linear polymer molecule of equivalent weight.

For these particular Examples, the advantage of using gpcBR in comparison to a traditional “g′ index” and branching frequency calculations is due to the higher precision of gpcBR. All of the parameters used in the gpcBR index determination are obtained with good precision and are not detrimentally affected by the low 3D-GPC detector response at high molecular weight from the concentration detector. Errors in detector volume alignment also do not affect the precision of the gpcBR index determination.

### Zero Shear Viscosity

Zero shear viscosity is determined by creep testing as discussed in Sammler, R. L., T. P. Karjala, W. Huang, M. A. Mangnus, L. G. Hazlitt, and M. S. Johnson, “Zero-Shear Viscosity/Molecular Weight Method for the Detection of Long-Chain Branching in Polyolefins”, SPE ANTEC Proceedings, Chicago, 1023 (May 17-20, 2004).

A zero-shear viscosity value (η₀), in Pascal-seconds at 190° C., is obtained via a creep test that is conducted on an AR-G2 stress controlled rheometer (TA Instruments; New Castle, Del.) using 25-mm-diameter parallel plates maintained at 190° C. Two thousand ppm of antioxidant, a 2:1 mixture of IRGAFOS 168 and IRGANOX 1010 (Ciba Specialty Chemicals; Glattbrugg, Switzerland), is added to stabilize each sample prior to compression molding. At the testing temperature a compression molded sample disk is inserted between the plates and allowed to come to equilibrium for 5 minutes. The upper plate is then lowered down to 50 μm above the desired testing gap (1.5 mm). Any superfluous material is trimmed off and the upper plate is lowered to the desired gap. Measurements are done under nitrogen purging at a flow rate of 5 L/minute. The creep time is set for 2 hours.

A low shear stress of 20 Pascals is applied for all of the samples to ensure that the shear rate is low enough to be in the Newtonian region. The expected steady state shear rates are in the range of 10⁻³ to 10⁻⁴ s⁻¹ for the samples in this study. Steady state is determined by taking a linear regression for all the data in the last 10% time window of the plot of log (J(t)) vs. log(t), where J(t) is creep compliance and t is creep time. If the slope of the linear regression is greater than 0.97, steady state is considered to be reached. The steady state shear rate is determined from the slope of the linear regression of all of the data points in the last 10% time window of the plot of ε vs. t, where ε is the strain. The zero-shear viscosity is determined from the ratio of the applied stress (20 Pascals) to the steady state shear rate.

A small amplitude oscillatory shear test is conducted before and after the creep test on the same specimen from 0.1 to 100 radians/second. The complex viscosity values of the two tests are compared. If the difference of the viscosity values at 0.1 radians/second is greater than 5%, the sample is considered to have degraded during the creep test, and the result is discarded.

WO2009/114661(A1) and WO2006/049783 are publications that are referenced herein for more specific information relating to polymerization conditions useful for making the claimed polymers.

What is claimed is:

1. A reaction product comprising ethylene and at least one cyclic phosphine wherein the reaction product has a non-extractable phosphorous concentration of at least 10 parts per million by weight.

2. The reaction product of claim 1, wherein the reaction product has a density from about 0.90 to about 0.94 in grams per cubic centimeter, a molecular weight distribution (M_{w}/Mₙ) from about 2 to about 30.

3. The reaction product of claim 1 wherein the product is odorless.

4. The reaction product of claim 1, wherein the cyclic phosphine corresponds to the following structure: 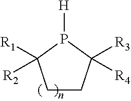
wherein n is an integer from 0 to 10.

5. The reaction product of claim 4 wherein R₁, R₂, R₃, and R₄ are not hydrogen.

6. The reaction product of claim 4 wherein R₁, R₂, R₃, and R₄ are independently selected from the group consisting of C₁-C₆ alkyl groups.

7. A reaction product consisting essentially of ethylene and at least one cyclic phosphine wherein the reaction product has a non-extractable phosphorous concentration of at least 10 parts per million by weight, wherein the reaction product comprises no additional anti-oxidant.

8. The reaction product of claim 4 wherein the reaction product has a density from about 0.90 to about 0.94 in grams per cubic centimeter, a molecular weight distribution (M_{w}/Mₙ) from about 2 to about 30.

9. A film layer comprising the reaction product of claim 1.

10. A composition comprising the reaction product of claim 1 and at least one other natural or synthetic polymer.

11. The composition of claim 10 wherein the synthetic polymer is selected from the group consisting of HDPE, LLDPE, LDPE, OBC, polypropylene, homogeneous linear ethylene polymers, and homogeneous substantially linear ethylene polymers.

12. The reaction product of claim 1 wherein the reaction product has been at least partially cross-linked to a gel level of at least 5 weight percent.

13. The reaction product of claim 1 comprising at least one chain transfer agent other than a cyclic phosphine.

14. The reaction product of claim 1 further comprising at least one C₃-C₂₀ alpha olefin.

15. The reaction product of claim 1 having a long chain branching structure as characterized by a gpcBR value greater than 0.05 as determined by a gpcBR Branching Index and a GPC-LS Characterization value greater than 2.1 as determined by a GPC-LS Characterization method.
